(19) United States
(12) Patent Application Publication
(10) Pub. No.: US 2004/0078876 A1
(43) Pub. Date: Apr. 29, 2004

(54) Immersion suit

(75) Inventor: Andrew William Wilson, Aberdeen (GB)

Correspondence Address: DRINKER BIDDLE & REATH, ONE LOGAN SQUARE, 18TH AND CHERRY STREETS, PHILADELPHIA, PA, 19103-6996, US

(73) Assignee: Multifabs Survival Limited, Aberdeen (GB)

(21) Appl. No.: 10/641,484

(22) Filed: Aug. 15, 2003

(30) Foreign Application Priority Data
Aug. 17, 2002 (GB) 0219242.5

(51) Int. Cl. A62B 17/00; A62D 5/00

(52) U.S. Cl. 2/458

(57) ABSTRACT

An immersion suit having torso and leg compression straps which can be stowed by attaching them to the body of the immersion suit by way of hook and loop fasteners. The compression straps drive out air trapped inside and thus reduce the bulkiness of the suit. This reduces the likelihood for the suit to snag on objects which could impede the wearer's escape from, for example, a submerged aircraft. The convenient stowing of the straps also reduces the likelihood of the compression straps being caught on objects. In preferred embodiments, the compression strap comprises a first face of hook material and a second opposite face of loop material to enable one end of the compression strap to be affixed over an opposite end of the compression strap when stowed.

### RELATED APPLICATIONS

This application is related to and claims priority from United Kingdom Application No. 0219242.5, filed Aug. 17, 2002.

### FIELD OF THE INVENTION

This invention relates to an immersion suit and particularly but not exclusively to an immersion suit for aircraft occupant escape survival suits for use in both fixed wing and helicopter and also maritime abandonment suits.

### BACKGROUND OF THE INVENTION

Immersion dry suits are employed as an aid to survival for aircraft occupants in the event of an aircraft ditching at sea. Immersion dry suits are also employed as aids for survival for offshore personnel in the event of a vessel or offshore installation having to be abandoned.

Such immersion suits are generally waterproof and often breathable coveralls with attached feet, a waterproof entry zipper and rubber seals at the neck and wrist. The immersion suit may be worn constantly or put on only in the event of an emergency. An immersion suit may provide some inherent insulation or may only provide a watertight barrier protecting the insulation of the clothing worn underneath.

Immersion suits for abandonment applications are designed to cater for a wide size-range of potential users. However, offering a wide range of sizes is not desirable since in the event of an emergency, presenting a wide range of sizes to an abandonee would cause confusion and delay escape. Therefore, immersion suits are preferably designed to provide “one size fits all”.

Such abandonment immersion suits are generally designed to be used once only in the event of an emergency. Also, such suits are designed to be put on over whatever clothing is worn at the onset of the emergency, including footwear; the user merely puts on the suit over all clothing worn.

A “one size fits all” immersion suit must cater for the wide degree of anthropometric variation in a given population, typically 5^{th} percentile female to 95^{th} percentile male, from the smallest female to the largest male. Typically, such a garment is sized to fit the largest identified user and then a number of volume reducing means are incorporated to enable the smallest user to reduce the size of the garment to an acceptable fit.

An immersion suit protects the wearer in two ways; reducing the effects of cold shock and protecting the thermal insulation within. Sudden immersion in cold water has a profound effect on the individual. The body's involuntary physiological effects of sudden immersion in cold water are known as “cold shock”. Cold shock causes increased heart rate, the constriction of blood vessels, rise in blood pressure, reflex gasping, hyperventilation and the aspiration of water. Cold shock can cause an individual to drown or to suffer heart problems.

The wearing of an immersion dry suit can significantly reduce the effects of this initial cold shock. However, the wearing of any immersion dry suit introduces the risk of additional buoyancy, as air is trapped within the immersion coverall. In the case of an aircraft ditching, this buoyancy can prevent a successful egress from an immersed cabin with fatal consequences.

Excess buoyancy can also impair the performance of a lifejacket. Excess buoyancy within an immersion dry suit can disrupt the buoyancy distribution given by the lifejacket, compromising the wearer's floating position. Excess buoyancy can also prevent the lifejacket from self-righting a passive survivor lying face-down in the water. In each instance, excess buoyancy can compromise the performance of the lifejacket in protecting the survivor's airways. The additional buoyancy provided by wearing an immersion suit can be minimised by reducing the amount of air trapped within the immersion suit. The more closely fitting the immersion suit, the less potential for trapped air, as the amount of excess volume within the suit is minimised.

In the case of a “one size fits all” immersion suit for abandonment purposes, the volume reducing means incorporated to enable the smallest user to reduce the size of the garment to an acceptable fit also reduce the excess volume and hence reduce the maximum buoyancy of the immersion suit. However, it is desirable to also reduce the inherent buoyancy of the garment to a minimum, and this is achieved by venting the immersion suit.

The amount of additional buoyancy can be reduced by two methods of venting the immersion dry suit; either manually or automatically. The manual technique relies on the user employing a technique whereby they break and hold the neck seal of the immersion coverall open and away from the neck, squat down, maintain this position whilst the air is vented through the neck seal, then close the neck seal before standing up. The automatic system is typically achieved by providing sensitive one way valves on the suit which allow air to move from within the suit to outside the suit when the pressure inside the suit exceeds that outside the suit e.g. when the user is immersed in water.

Commonly, the preferred method of adjusting the fit of a “one size fits all” immersion suit is to provide means of tightening or cinching at the ankle and waist of the garment. These cinching means may take the form of straps that are knotted tight, belts that are buckled tight, or compression straps that use a friction lock buckle. Commonly, one strap is located at each ankle and two straps, one at each side of the waist are employed.

However, a potential for risk is that, once tightened, such strapping then present a loose length of strap or webbing belt that can present a snagging hazard.

### SUMMARY OF THE INVENTION

According to a first aspect of the present invention there is provided an immersion suit including a body and a compression strap, wherein the compression strap is capable of engagement with a portion of the body by means of a hook and loop fastener.

Preferably, the body comprises a covered channel which covers a portion of the compression strap. Preferably, the compression strap is adapted to extend outwith the channel and is capable of engagement with an outer face of the channel.

The invention also provides an immersion suit comprising at least one compression strap and a covered channel, a portion of the compression strap being provided in the channel, wherein the compression strap is adapted to extend outwith the channel and is capable of engagement with an outer face of the channel.

Preferably, the engagement of the compression strap with the channel is provided by hook and loop fasteners.

Preferably, the compression strap is moveable from a first position to a second position to compress a portion of the suit in order to make the suit tighter fitting.

Preferably, the compression strap extends from the channel through a buckle member secured to the suit and back towards the channel for engagement therewith.

Preferably, the compression strap is moveable through the buckle member which may be a friction lock buckle. Preferably, the friction lock buckle is of a conventional size.

Preferably, the compression strap comprises a first face having at least one of hook or loop material for engagement with the other one of hook or loop material provided on the outer face of the channel.

Preferably, the compression strap further comprises a second opposite face. Preferably, the second face of the compression strap has the other one of hook or loop material to the one of the first face of the compression strap. Preferably, the first face and second face are moulded together. More preferably, they are held together substantially by adhesive bonding.

The compression strap may be a torso compression strap provided around a torso of the suit, a leg compression strap provided around a leg portion of the suit, or another compression strap provided elsewhere on the suit.

Preferably, the torso compression strap has two opposite ends, namely a first end and a second end, and each end extends outwith the channel and is capable of engagement with an outer face of the channel. Alternatively a second torso compression strap may be provided which extends outwith the channel in the opposite direction from the first torso compression strap and is capable of engagement with an outer face of the channel.

Preferably, the lower face of each end of the torso compression strap is capable of engagement with the upper face of the other end of the torso compression strap. Alternatively, where a second torso compression strap is provided, the lower face of each torso compression strap is capable of engagement with the upper face of the other torso compression strap.

Preferably, the first face of the leg compression strap has a portion of hook material and a portion of loop material. Preferably, an end of the first face of the leg compression strap has one of hook and loop material and the remaining portion of the face has the other of hook and loop material. Preferably, the end of the leg compression strap forms an abutment with the buckle and is not permitted to move therethrough.

Preferably, the end of the leg compression strap is capable of engagement with the remaining portion of the leg compression strap and is also capable of engagement with the outer face of the channel.

### BRIEF DESCRIPTION OF THE FIGURES

An embodiment of the present invention will now be described by way of example only, wherein:

FIG. 1 is a diagrammatic front view of a waterproof immersion coverall in accordance with the present invention;

FIG. 2 is a diagrammatic back view of the waterproof immersion coverall of FIG. 1;

FIG. 3A is a diagrammatic front view of a waist cinching system of the coverall of FIG. 1;

FIG. 3B is a diagrammatic rear view of the waist cinching system of FIG. 3A;

FIG. 4A is a diagrammatic detail “A” of the waist cinching system of FIG. 3A in an untightened position;

FIG. 4B is a diagrammatic detail “A” of the waist cinching system of FIG. 3A in a tightened position;

FIG. 4C is a second diagrammatic detail “A” of the waist cinching system of FIG. 3A, illustrating a combined hook and loop material;

FIG. 4D is a diagrammatic detail of a waist cinch pull-tab of the waist cinching system of FIG. 3A;

FIG. 5A is a diagrammatic detail “B” of the waist cinching system of FIG. 3B in the untightened position;

FIG. 5B is a diagrammatic detail “B” of the waist cinching system of FIG. 3B in the tightened position;

FIG. 5C is a diagrammatic detail “B” of the waist cinching system of FIG. 3B, in a stowed position;

FIG. 6A is a diagrammatic rear view of the waist cinching system of the coverall of FIG. 1, in the untightened position;

FIG. 6B is a diagrammatic rear view of the waist cinching system of FIG. 6A, in a partially tightened position;

FIG. 6C is a diagrammatic rear view of the waist cinching system of FIG. 6B, with a first compression strap being in the stowed position and a second compression strap being in a tightened position;

FIG. 6D is a diagrammatic rear view of the waist cinching system of FIG. 6C, with each compression strap being in the stowed position;

FIG. 7A is an outer diagrammatic view of an ankle cinching system of the coverall of FIG. 1;

FIG. 7B is an inner diagrammatic view of the ankle cinching system of FIG. 7A;

FIG. 8A is a diagrammatic view of the ankle cinching system of FIG. 7A in an untightened position;

FIG. 8B is a diagrammatic view of the ankle cinching system of FIG. 8A in a partially tightened position;

FIG. 8C is a diagrammatic view of the ankle cinching system of FIG. 8B in a tightened position illustrating the combined hook & loop material.

### DETAILED DESCRIPTION OF THE INVENTION

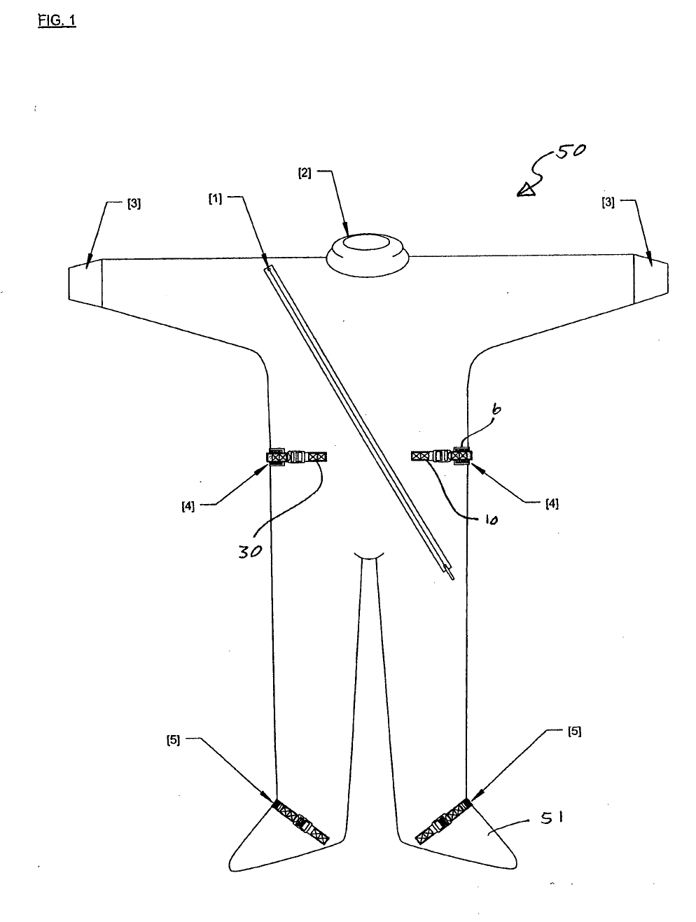

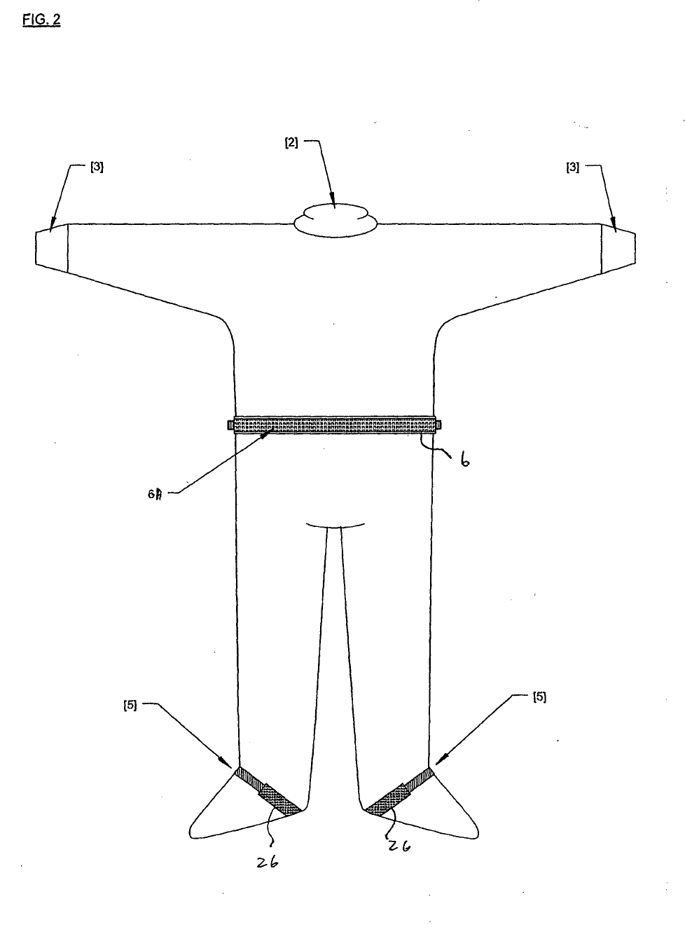

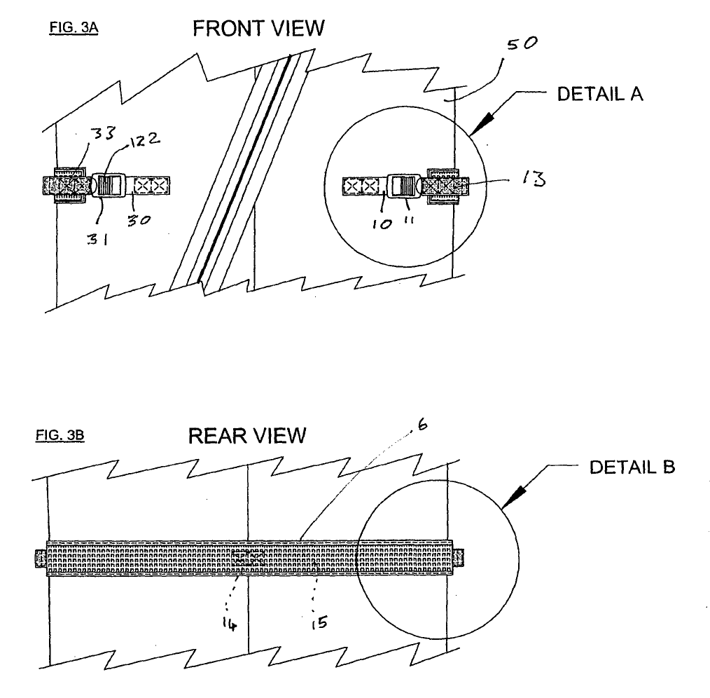

A waterproof immersion coverall dry suit or garment is shown in FIG. 1 and comprises a one-piece suit 50 with attached waterproof socks 51. The suit 50 comprises a waterproof main entry zip 1, neck 2 and wrist 3 watertight seals. The zip 1 extends diagonally down the front of the suit 50 from the right shoulder to left hip.

The suit 50 is typically made from a three layer, waterproof, breathable laminate material such as a Gortex™ type material, or alternatively from any of a range of waterproof non-breathable fabrics. The suit 50 comprises a number of flat pattern pieces assembled using techniques appropriate to the material. This could be by adhesive only, or by the use of stitching and then the use of hot melt adhesive seam sealing tape. The seals 2, 3 are typically made from latex or neoprene.

The suit 50 is large enough to fit most people and is designed to be easily and quickly put on in an emergency situation, for example, where an aircraft has ditched in water. When worn by smaller people there will exist a degree of excess capacity which could snag during an escape from a ditched aircraft or provide unwanted buoyancy to a wearer trying to escape from an immersed cabin.

A waist cover 6 extends from one side of the suit 50, around the back of the suit 50 to the other side of the suit 50 and forms a passage or channel between the waist cover 6 and the suit 50 through which a waist compression strap 12 may extend, as described below. An ankle cover 26 is provided on each leg portion of the suit to form further passages between each leg portion and each ankle cover 26.

50 mm wide loop piles 6A, 26A are sewn onto an outer face of the waist 6 and ankle covers 26 respectively and are adapted to engage with corresponding hook piles 12H, 22H as described below. The ankle cover 26 extends from the heel of the sock 51 along the line of a strap 22.

A waist cinching system 4 is provided to make the suit 50 more tight-fitting and thus reduce a proportion of this excess capacity. The waist cinching system 4 comprises a 25 mm wide compression strap 12 with a first end 121 and a second end 122, two anchor portions 10, 30 and two friction lock buckles 11, 31. The anchor portions 10, 30 are made from 25 mm wide narrow woven fabric webbing and are folded through the friction lock buckles 11, 31 respectively. The anchor portions 10, 30 are then doubled back on themselves and box-stitched onto the suit 50 to secure the friction lock buckles 11, 31 to the suit 50. Thus, the anchor portions 10, 30 cannot move through the buckles 11, 31.

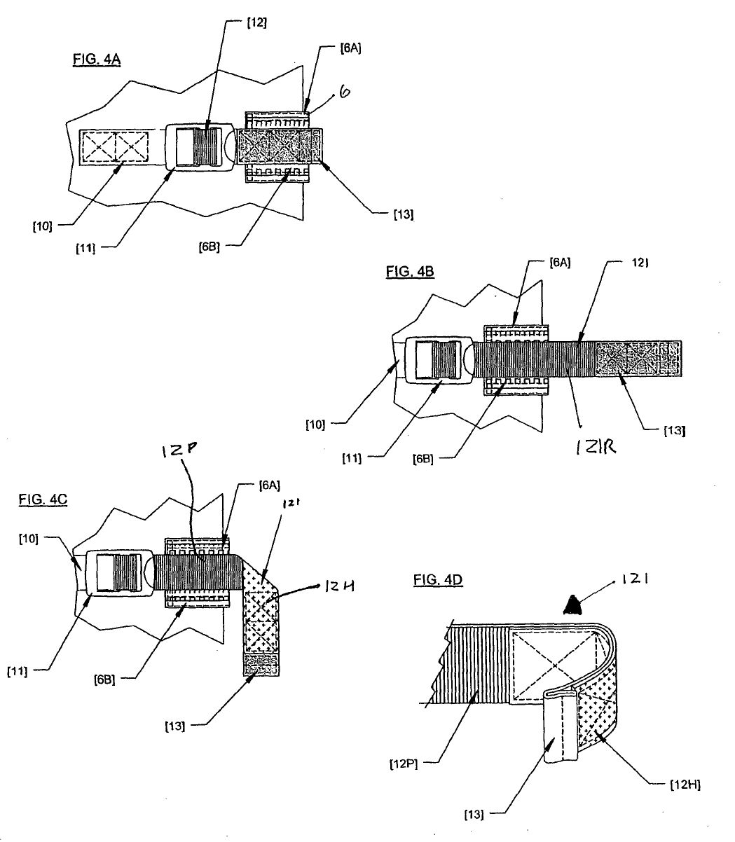

The first end 121 of the strap 12 comprises a first grip tag 13. The grip tag 13 is made from a narrow 25 mm wide woven fabric webbing, typically nylon, and is of a high visibility colour, such as yellow, for ease of location by the user. The end of the grip tab 13 is folded over twice and stitched for ease of gripping by the user, best shown in FIG. 4D.

The first end 121 of the strap 12 is looped around a portion of the first friction lock buckle 11 and may be moved through the buckle 11 by the user pulling on the grip tag 13. However the thickness of the grip tab 13 is such that the first end 121 of the strap 12 cannot be pulled all the way back through the buckle 11 by the user.

The strap 12 extends from the friction lock buckle 11 through the passage or channel formed between the waist cover 6 and the suit 50, around the back of the suit 50 and then out of the said passage to form a second end 122 of the strap 12 at the other side of the suit 50. The second end 122 continues from the passage and loops around a second friction lock buckle 31 and ends in a second grip tab 33; that is, it adopts the opposite configuration of its first end 121.

The strap 12 is typically stitched to the centre back 14 of the suit 50 within the passage to centre the strap 12 to prevent it from being pulled predominantly to one side or indeed all the way through the passage.

The strap is made from a One Wrap® type material. This material is disclosed in U.S. Pat. Nos. 5,518,795; 5,260,015 and 5,744,780 and Canadian Patent Application No 210550 the disclosures of which are incorporated herein by reference. ONE-WRAP® type material combines the previously separate elements of a touch and close fastening system, in that the hook and loop faces have been integrated such that the loop pile is on one face of the strap and the hook element on the other face of the strap. The hook element is typically of a low profile design, precision formed from extruded low-density polyethylene. This is then laminated to a nylon knit loop.

The inner face of the passage is of a suitably low friction finish to facilitate free running of the strap 12 which may otherwise catch due to the hooks provided thereon.

The strap 12 comprises a first inner face of hook elements 12H and an opposite outer face of a loop pile 12P. The hook elements 12H at each end 121, 122 of the strap 12 can engage with either the loop pile 6A on the waist cover 6 or the loop pile 12P at the other end 122, 121 of the strap 12.

One benefit of using the One-Wrap® material is that the first and second faces are held together by moulded plastic as described in U.S. Pat. No. 5,260,015 which obviates the need for introducing foreign materials to hold the faces together. This allows the material to be relatively thin to freely move through the buckles 11, 31. The profile of the hooks are also relatively small to facilitate this further.

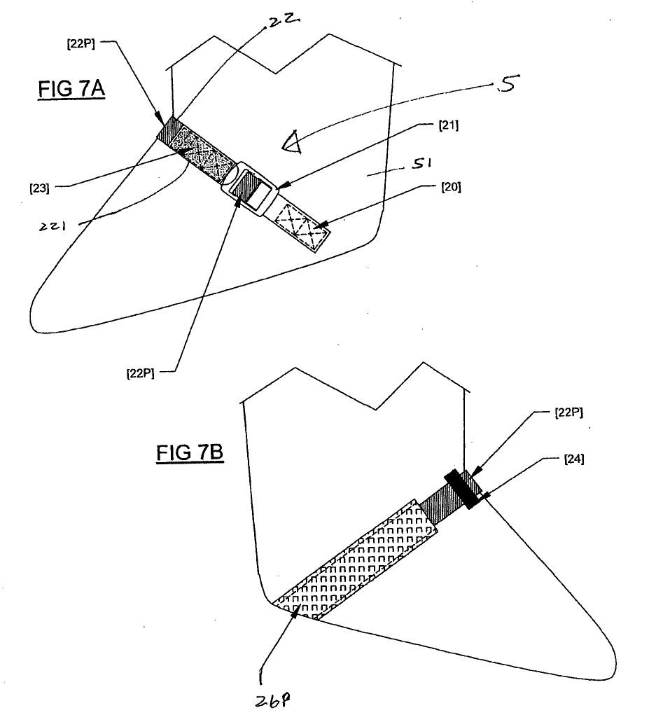

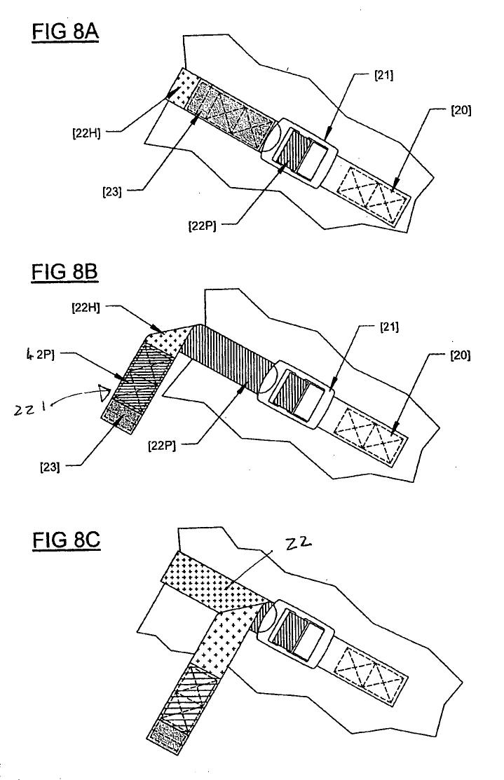

An ankle cinching system 5 is shown in more detail in FIGS. 7A, 7B & 8A-C. An ankle cinching system 5 is provided on each leg of the immersion suit 50 (as shown in FIG. 1) and each system 5 comprises a compression strap 22, an anchor portion 20 and a friction lock buckle 21. The anchor portion 20 is folded through the plastic friction lock buckle 21, doubled back on itself and box stitched onto the suit 50. The anchor portion 20 cannot move through the buckles 21.

The first end 221 of the strap 22 also comprises a narrow 25 mm woven fabric webbing wide grip tag 23 of a high visibility colour such as yellow. The grip tab 23 has its end folded over twice and stitched to form a tab for ease of gripping.

The strap 22 is looped around a portion of the buckle 21 and may be moved through the buckle 21 by the user pulling on the grip tag 23 although, like the waist strap 12, the thickness of the pull tab 23 is such that the strap 22 cannot be pulled all the way through the buckle 21 by the user.

The strap 22 extends from the friction lock buckle 21 under a retaining loop 24 which is provided to prevent a portion of the sock 51 from passing through the loop of the strap 22, and into the passage formed between the ankle cover 26 and the leg portion of the suit 50 and is secured therein by stitching (not shown.)

The ankle compression strap 22 is similar to the waist compression strap 12 and is made from a 25 mm wide ONE-WRAP® type black narrow fabric laminate. The strap 22 comprises a first outer face of hook elements 22H and an opposite inner face of a loop pile 22P. A first end 221 of the strap 22 has a further loop pile 42P secured to the outer “hook” face of the strap 22.

Thus for the portions of the strap 22 between the ankle cover 26 and the lock buckles 21, the hook elements 22H are facing outwards whereas for the portion of the strap 22 between the lock buckles 21 and the first end 221, the hook elements 22H are facing inwards.

The inwardly facing hook elements 22H on the strap 22 can engage with the loop pile 26P on the ankle cover 26 or alternatively the loop pile 42 at the end of the strap 22 can engage with the outwardly facing hook elements 22H on the strap 22.

In use, the user puts on the suit and closes the zip 1. The user disengages the strap 12 from the cover 6 by lifting the grip tag 13 of the first end 121 of the strap 12 which disengages the hook elements 12H from the loop pile 26P, and then pulls on the grip tag 13 causing the compression strap 12 to be pulled through the friction lock buckle 11. The friction lock buckle 11 does not move with the compression strap 12 because it is held substantially stationary by the anchor portion 10. The length of the strap 12 between the friction lock buckle 11 and the stitching 14 is thereby reduced which causes the strap 12 to compress the suit 50 and tighten the fit around the user at one side of the suit 50.

The grip tab 33 of the second end 122 of the waist compression strap 12 is similarly pulled through its friction lock buckle 31 to cause the other side of the suit 50 to compress and tighten around the user.

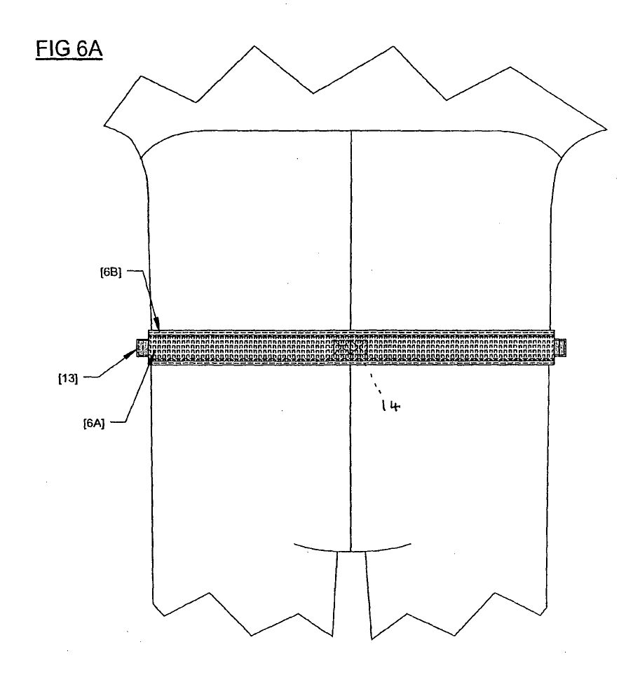

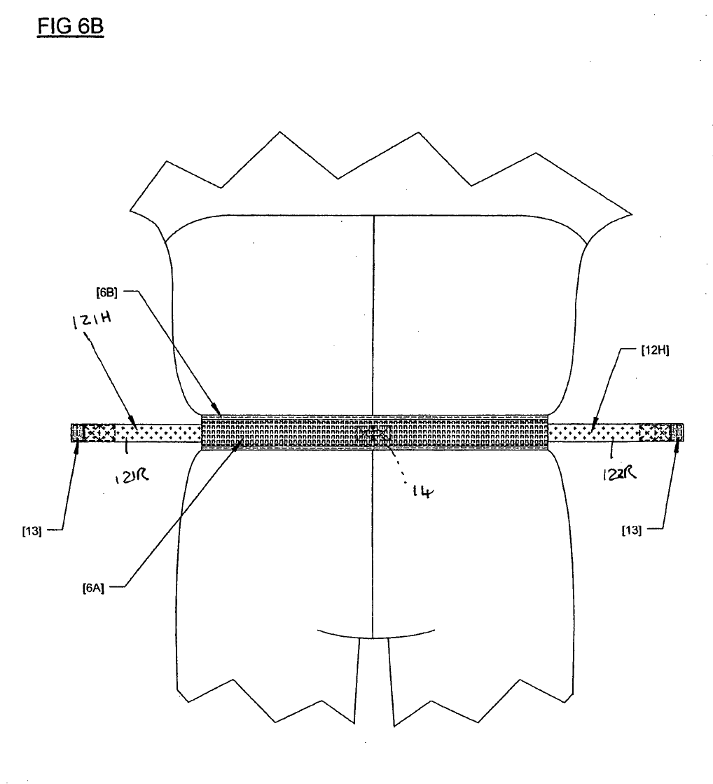

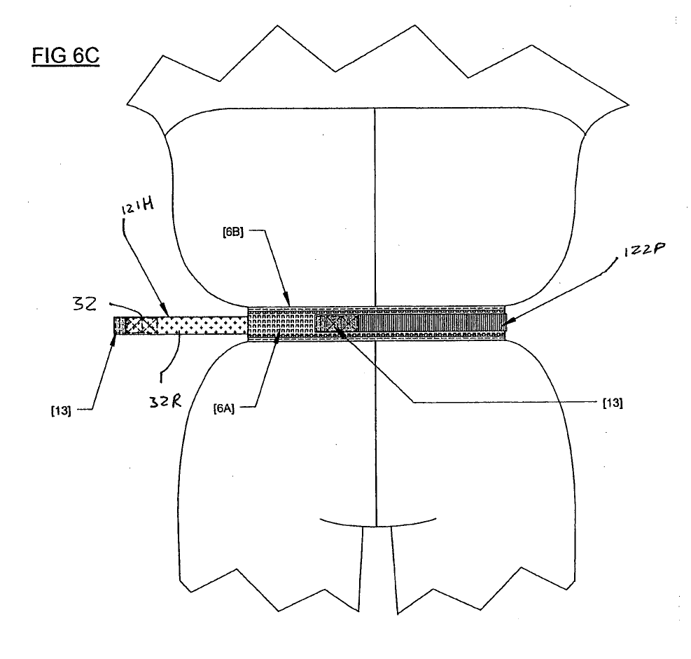

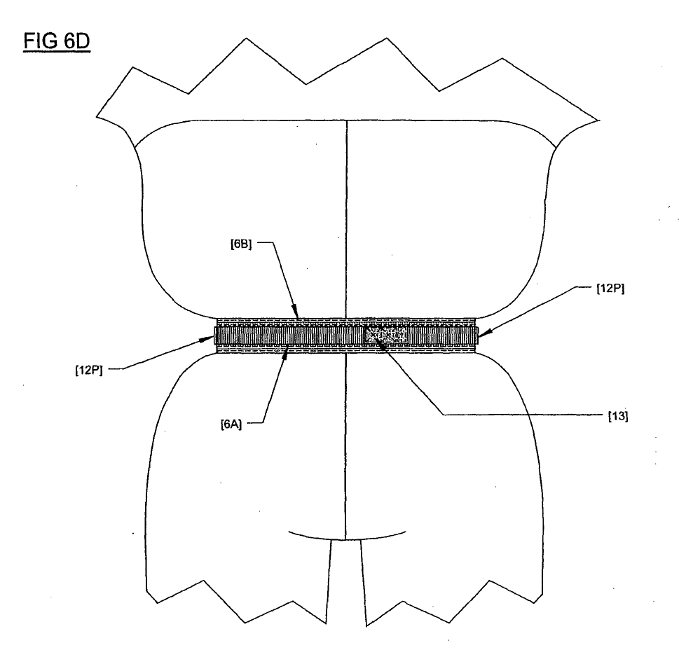

The operation of the strap 12 in this way results in residual portions of the strap 121R, 122R (“residual strap”) between the buckles 11, 31 and the first end 121 and second end 122 of the strap 12 respectively, that is, the portion of the strap 12 which has been pulled through the buckles 11, 31, as shown in FIG. 6B. The length of the residual strap 121R, 122R is inversely proportional to the size of the user—a relatively large user will only need to pull the strap 12 a relatively short distance until the suit 50 has tightened around them resulting in relatively short residual straps 121R, 122R (or perhaps none at all) whereas a relatively small user would need to pull the strap 12 further through the buckles 11, 31 to tighten the suit around them resulting in longer residual straps 121R, 122R.

If these residual straps 121R, 122R are not properly stowed, they can snag during escape and impede the user's escape from, for example, a ditched aircraft.

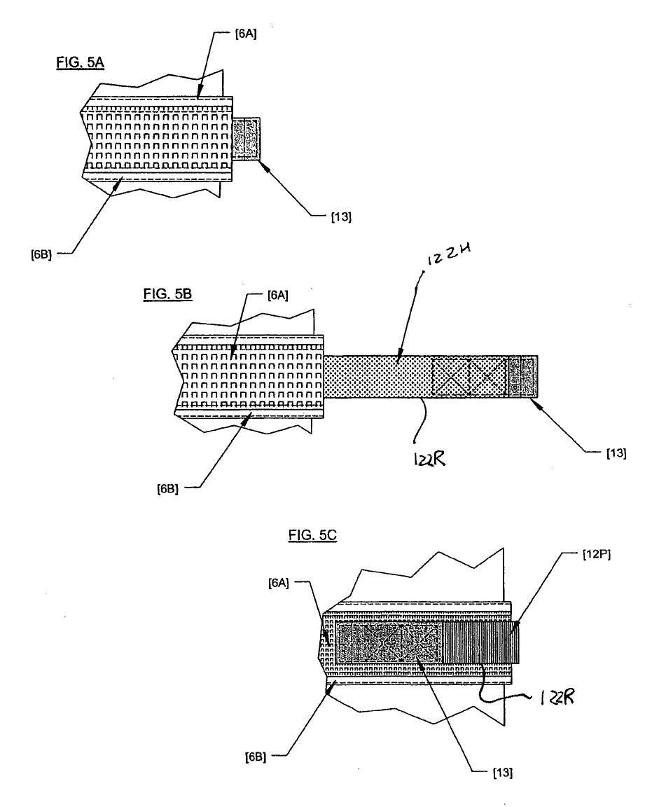

Here, the residual strap 122R is placed around the waist of the suit 50 over the loop pile 6a of the cover 6 as shown in FIGS. 5B and 5C. The hooks 122H on one face of the second end 122 of the strap 12 engage with the loop pile 6a on the cover 6 to hold the second end 122 of the strap 12 around the waist and so stop the residual strap 122R hanging loose and so significantly reduce the possibility of snagging.

Similarly the residual strap 121R is also placed around the waist of the user and, assuming the first residual strap 121R does not overlap with the second residual strap 122R, the hooks 121H of the first end 121 of the strap 12 engage with the loop pile 6A on the waist cover 6.

However, for smaller users where the residual straps 121R, 122R are relatively long and so overlap at the back of the suit 50, the hooks 121H of the first end of the strap 121 engage with the loop pile 122P on the opposite face of the second residual strap 122R, as shown in FIGS. 6C, 6D.

Thus there may exist three engaging layers; the loop pile 6A on the cover 6 engaging with the hooks 122H on a second end of the residual strap 122R and the loop pile 122P on the opposite face of the second end of the residual strap 122R engaging with hooks 121H on the first end of the residual strap 121R which is placed over the second residual strap 122R.

Therefore each end of the compression strap 12 may be conveniently stowed preventing these residual portions of the strap 12 from snagging during escape.

A benefit of certain embodiments of the invention is that there are no portion of straps dangling from the suit which can snag during an escape.

Another benefit of certain embodiments of the invention, such as the suit 50, is that the portion of the strap 12 which is tightened around the user is substantially covered by the cover 6 which also reduces the possibility of snagging.

A further benefit of embodiments of the invention is that the excess portions of the straps 121R, 122R may be quickly and intuitively stowed without the need for more careful stowing of the straps by, for example traditional belt loops.

The utilisation of ONE-WRAP® type material for the strap 12 enables the second end 122 of the compression strap 12 to overlap, engage and fasten with the first end 121 of the compression strap 12. In this manner, both ends 121, 122 of the straps can be effectively secured and the potential for snagging hazard significantly reduced.

A further benefit of using ONE-WRAP® type material for certain embodiments is that it has a relatively thin profile which can move through commercially available lock buckles, such as the lock buckles 11, 21 and 31.

A yet further advantage of embodiments of the invention is that the engagement of one of the straps on a cover will not impede the stowing of a further portion of a strap because the One Wrap® type material has a face of hooks on one side and a face of loops on a second opposite side.

Each of the ankle compression straps 22 are also pulled through their respective lock buckles 21 by the user pulling on the grip tab 23 to compress the leg portions of the suit 50 around the wearer to provide a tighter fit. The portion of each ankle compression strap 22 pulled through the ankle buckle 21 can be stowed by placing it against the loop pile 26P on the cover 26 so that the hook elements 22H on the strap 22 engage with the loop pile 26P on the cover 26.

However for those wearing bulky footwear the straps 22 may require little or no adjustment and so the outer end 221 of the strap 22 may not reach the cover 26 for engagement therewith. In such circumstances, the loop pile 42P secured to the end 221 of the strap 22 engages with the hooks 22H on a portion of the strap 22 between the cover 26 and the buckle 21.

Therefore, regardless of the user's size, the ankle compression straps 22 may be safely stowed to significantly reduce the potential for snagging.

The air within the suit 50 can escape through valves (not shown) in the shoulders or ankles of the suit 50 and can be encouraged to do so by the user squatting down. If no valves are provided the user can squat down and then break the neck seal 2 to allow air to escape between the user and the neck seal 2.

For certain embodiments of the suit 50, the suit 50 is predominantly of a black colour in order to the camouflage the user in a combat situation. The grip tabs 13, 23 however are of a high visibility colour to bring to the users attention the parts of the suit 50 which operate the waist 4 and ankle 5 cinching systems.

Typically the suit 50 is stored in a hermetically sealed pouch which may be made from silver foil. This obviates the need for regular maintenance of the suit, for example chalking the suit 50 periodically is not required.

Further tags (not shown) may be provided on the arms of the suit 50 in order for the user to pull his/her hands through the wrist seals 3.

Pouches (not shown) containing hoods and/or gloves may also be provided. Typically such pouches are made from a mesh like material in order to allow water to drain therefrom and reduce the drag of the suit, which is particularly important when the user is being removed from the water.

Modifications and improvements may be made without departing from the scope of the invention for instance the single waist compression strap 12 may be replaced by two waist compression straps (not shown) each of which extend from the stitching 14 out either side of the passage and are arranged and operate like the first 121 and second 122 ends of the strap 12.

I claim:

1. An immersion suit comprising a suit body portion and a compression strap, wherein the compression strap is capable of engagement with a portion of the suit body portion by means of a hook and loop fastener.

2. An immersion suit as claimed in claim 1, wherein the suit body portion comprises a channel which encloses a portion of the compression strap.

3. An immersion suit as claimed in claim 2, wherein a second portion of the compression strap is adapted to extend outwith the channel and is capable of engagement with an outer face of the channel.

4. An immersion suit as claimed in claim 2, wherein a second portion of the compression strap extends from the channel through a buckle member secured to the suit body portion and back towards the channel for engagement with an outer face thereof.

5. An immersion suit as claimed in claim 4, wherein the buckle member is a friction lock buckle.

6. An immersion suit as claimed in claim 2, wherein the compression strap comprises a first face having at least one of hook or loop material for engagement with the other one of hook or loop material provided on an outer face of the channel.

7. An immersion suit as claimed in claim 1, wherein the compression strap comprises a first face having at least one of hook or loop material and a second opposite face having the other one of hook or loop material.

8. An immersion suit as claimed in claim 7, wherein the first and second faces of the compression strap are moulded together.

9. An immersion suit as claimed in claim 1, wherein the compression strap is moveable from a first position to a second position to compress a portion of the suit in order to make the suit tighter fitting.

10. An immersion suit as claimed in claim 2, wherein the compression strap is a torso compression strap provided around a torso of the suit.

11. An immersion suit as claimed in claim 10, wherein the torso compression strap has two opposite ends, namely a first end and a second end, and each end extends outwith the channel and is capable of engagement with an outer face of the channel.

12. An immersion suit as claimed in claim 11, wherein a lower face of each end of the torso compression strap is capable of engagement with an upper face of the other end of the torso compression strap.

13. An immersion suit as claimed in claim 2, wherein the compression strap is a leg compression strap provided around a leg portion of the suit.

14. An immersion suit as claimed in claim 13, wherein a first face of the leg compression strap has a portion of hook material and a portion of loop material.

15. An immersion suit as claimed in claim 13, wherein an end of a first face of the leg compression strap has one of hook and loop material and the remaining portion of the face has the other of hook and loop material.

16. An immersion suit as claimed in claim 13, comprising a buckle member secured to the suit body portion through which a portion of the leg compression strap extends and wherein an end thereof forms an abutment with the buckle and is not permitted to move therethrough.

17. An immersion suit as claimed in claim 13, wherein an end of the leg compression strap is capable of engagement with the remaining portion of the leg compression strap and is also capable of engagement with an outer face of the channel.

18. An immersion suit comprising at least one compression strap and a channel, a portion of the compression strap being enclosed by the channel, wherein the compression strap is adapted to extend outwith the channel and is capable of engagement with an outer face of the channel.

19. An immersion suit as claimed in claim 18, wherein the engagement of the compression strap with the channel is provided by hook and loop fasteners.
